(19) United States
(12) Patent Application Publication
(10) Pub. No.: US 2018/0261831 A1
(43) Pub. Date: Sep. 13, 2018

(54) LEAD-CARBON METAL COMPOSITE MATERIAL FOR ELECTRODES OF LEAD-ACID BATTERIES AND METHOD OF SYNTHESIZING SAME

(71) Applicant: Varvara Andreevna ELSHINA, Ekaterinburg (RU)

(72) Inventors: Liudmila Avgustovna ELSHINA, Ekaterinburg (RU); Andrey Nikolaevich ELSHIN, Ekaterinburg (RU)

(21) Appl. No.: 15/758,262

(22) PCT Filed: Sep. 7, 2015
(86) PCT No.: PCT/RU2015/000565

§ 371 Date: Mar. 7, 2018

(51) Int. Cl. H01M 4/16; H01M 10/06; C01G 21/14; H01M 4/583

(52) U.S. Cl. CPC H01M 4/16; H01M 10/06; H01M 2004/027; H01M 4/583; C01G 21/14

(57) ABSTRACT

The invention is directed to a radical improvement of the specific electrochemical and corrosive characteristics of a lead-acid battery without a drastic change in the process of battery producing. The lead-carbon metal composite material contains from 0.1 to 10% by weight of carbon, lead is the remainder, while the structure of the material contains carbon allotropic modifications from graphene to graphite. The method for material synthesizing is characterized in that lead or its alloys are melted in a melt of alkaline and/or alkaline earth metal halides containing from 1 to 20 wt. % of metal carbides or non-metals with a particle size of 100 nm to 200 μm, or solid organic substances, for 1-5 hours at a temperature of 700-900° C.

### TECHNICAL FIELD

The invention relates to the battery industry and can be used, in particular, as a new class of lead-carbon metal composite material for manufacturing current collectors used in lead-acid batteries.

### BACKGROUND OF THE INVENTION

Carbon materials have been widely used in recent years as additives to the cathode and anode materials of lead-acid batteries (PT Moseley, J. Power Sources 191 (2009) 134-138) [1], K. Nakamura, M. Shiomi, K. Takahashi , M. Tsubota, J. Power Sources 59 (1996) 153-1572) [2]. The mechanism of the favorable effect of carbon on the electrochemical behavior of lead-acid battery electrodes has not yet been fully investigated, but there are suggestions that carbon increases the capacity of the lead-acid battery (P. Simon, Y. Gogotsi, Nat. Mater. 7 (2008)) 845-854) [3]. Carbon can also serve as a secondary phase preventing the growth of lead sulfate crystallites and not allowing particles to agglomerate to larger objects (D. Pavlov, P. Nikolov., Journal of Power Sources 242 (2013) 380-399) [4].

Carbon materials used as additives to cathode paste and lead-acid battery anode are generally used in the form of carbon nanopowders, or as carbon nanotubes (X. Zou, Z. Kang, D. Shu, Y. Liao, Y. Gong, Ch. He, J. Hao, Y. Zhong, Electrochimica Acta 151 (2015) 89-98. [5] S W Swogger, P. Everill, D P Dubey, N. Sugumaran, J. Power Sources 261 (2014) 55-63) [6]. Pre-isolated as a separate phase, nanocarbon materials are mixed with the oxide base of the paste, or nanocarbon is produced directly in the oxide mass by joint pyrolysis of lead nitrate with organic compounds (B. Hong, L. Jiang, H. Xue, F. Liu, et al., Journal of Power Sources 270 (2014) 332-341) [7]. However, it is well known that all known methods for the isolation of carbon nanomaterials are very costly, and the methods associated with the pyrolysis of organic substances are environmentally unsafe.

The known composite materials of the “lead-carbon fiber” system, which are manufactured by impregnating a wireframe of fibers with a matrix melt under pressure or by electrolytic deposition of the matrix metal on the fiber, followed by hot pressing. In both cases composite materials containing up to 35% by volume carbon fiber can be obtained (Brautman LN Composite materials with metallic matrix T4, 1978, 504 p.) [8].

The application of carbon fibers to reinforce the lead matrix leads to a significant increase in specific and mechanical characteristics and even leads them to the level of the corresponding characteristics of carbon steels. In addition to purely structural applications, carbon-composite composites with a matrix based on copper, aluminum and lead are of interest in the combination of high strength with high electrical conductivity, low friction coefficient and high wear resistance, and good dimensional stability over a wide temperature range. In this connection, compositions based on copper, aluminum, lead and zinc can be considered as high-strength conductors of electric current and as high-strength antifriction materials. To drawbacks of the obtained composite materials of the system “lead-carbon” fiber it is necessary to classify the disadvantages traditional for composite materials: essential anisotropy of properties and high porosity.

Thus, a carbon-coated electrode for a lead-acid battery is known (RU 2314599, published on Jun. 27, 2005) [9], formed by the deposition of carbon layers 100 nm-1 μm thick on the lead basis of the current collector by the method of plasma deposition from a hydrocarbon vapor. The lead-carbon material formed in this way is a low-performance laminate, while the method for producing this material is very complex in hardware and experimentally because precipitation is possible only in a vacuum chamber at a residual pressure of less than 1×10-6 Torr, which is then filled with argon to a pressure of at least 1×10-3 Ton. In addition, it is difficult to guarantee good adhesion of the carbon layer obtained by this method to lead.

### DISCLOSURE OF INVENTION

The need to produce nanocomposites and lead alloys with carbon can be attributed to the need for creating the invention. It is assumed that to the aforementioned advantages of introducing carbon into the electrodes of a lead-acid battery, such as increasing capacity, preventing the formation of large lead sulphate agglomerates, it can be added that the use of lead-carbon metal electrodes would significantly improve the performance of the lead-acid battery for the reduction of the weight of the electrodes of the accumulator, increasing their electrical conductivity and electrochemical activity.

Another need in the use of lead-carbon metal electrodes is the expected increase in corrosion resistance of electrode materials; the carbon included in the alloy is not soluble in dilute sulfuric acid, which forms the basis of the sulfuric acid electrolyte in the accumulator. Therefore, it is expected that the use of lead-carbon metal material will prevent the destruction of current leads due to intergranular corrosion, which is characteristic of the currently used Pb—Ca, Pb—Sb, Pb—Sn alloys, which in turn will increase the service life of the lead-acid battery. Based on these prerequisites, a lead-carbon composite material is synthesized, which can be used to manufacture electrodes of lead-acid batteries.

The main obstacle to the creation of lead-carbon metal materials is the extremely low solubility of carbon in lead. It is also known that the non-transition metals Cu, Sn, Ag, Au, In, Sb, Bi, Ga, to which lead (Pb) also belong, are chemically inert with respect to carbon and form blunt edge fragments on the surface of graphite and diamond. The lead angle with respect to graphite at a temperature of 8000 C is 1380. In the claimed invention, it has been possible to synthesize a lead-carbon metal composite material containing from 0.1 to 10% by weight of carbon, the structure of which contains various carbon allotropic modifications—from graphene to graphite.

To synthesize such a material, lead or its alloys are melted in a melt of alkali and/or alkaline earth metal halides containing from 1 to 20 wt. % of metal carbides or non-metals with a particle size of 100 nm to 200 μm, or solid organic substances, for 1-5 hours at a temperature of 700-900° C. These conditions ensure unobstructed diffusion into the metal of carbon atoms, which are released by the interaction of molten lead with a carbon-containing additive, forming there various carbon allotropic modifications—from graphene to graphite—depending on the conditions of synthesis, cooling and subsequent heat treatment (FIG. 2, 4). The formation of lead-wettable phases of graphene and graphite inside metallic lead was recorded using Raman spectroscopy. Lead-carbon metal material with this structure has properties that allow it to be used as electrodes of a lead-acid battery.

The proposed method for producing a lead-carbon metal composite material (composite) is based on the direct chemical interaction of a carbide ion or atomic carbon from organic substances with lead or its alloys in a salt chloride and/or halide melt medium in a temperature range of 700-900° C. As a result, a synthesis of nano- and microparticles of carbon takes place in the molten lead matrix, and in one stage directly in molten lead without the need for a separate stage of synthesis and isolation of carbon nanomaterials. This significantly reduces the complexity and laboriousness of obtaining lead metal composites with a high carbon content.

The resulting lead-carbon composites are characterized by a uniform distribution of the carbon particles in the form of graphene layers or graphite crystals up to 10 nm to 100 μm in volume, which leads to high homogeneity of the properties of the composites. This method can be used to obtain gratings of lead accumulators of any shape and size, because the metal composite obtained by chemical interaction of the salt melt components with the molten lead can then be re-melted for mold casting or rolled using the classical technology without losing the original properties of the resulting composite.

The proposed method can be carried out without a special inert atmosphere, in an air atmosphere; it can be realized as follows. Powder of metal carbide or non-metal or solid organic substances such as oxalic acid or sucrose, mix with dry salt mixture, place metal lead over the carbide-containing salt mixture, fill it with a layer of salts, which after oxidation will prevent oxidation of the lead surface by air oxygen. After the salt and lead metal or its alloys have melted, the carbide powder or organic matter interacts with lead. Thus during high temperature interactions molten lead with carbide-ions or a solid organic substance occurs carbon emissions, either in the form of graphene sheets, or in the form of graphite crystals average size of 10 nm to 100 microns which during the interaction are distributed uniformly in molten metal bulk. The content of carbon inclusions in the synthesized material, as well as their size and allotropic modifications, can vary by the number and type of precursors—metal or nonmetallic carbides or solid organic substances.

The lower limit of the temperature range for the production of lead-carbon composite metal material −700° C., is determined from the melting temperature of halide salt electrolytes so that the entire volume of salts is guaranteed to be melted during the experiment and provides the molten lead with protection against oxidation by air oxygen. When the temperature rises above 900° C., a significant salt content is observed out the crucible, which worsens the environmental friendliness and process ability of the process.

In addition, an increase in the interaction temperature is undesirable due to an increased risk of lead carbide formation, which could adversely affect the corrosion resistance of lead-carbon metal materials. Because the rate of diffusion of carbon particles in molten lead is low, considerable time exposures are required—from 1 to 5 hours, so that the interaction reaction with the formation of graphene or graphite is most complete.

A new technical result achieved by the claimed invention is to obtain a homogeneous, low porosity and increased hardness and electrical conductivity of metallic lead-carbon composite material that can be used as grids of lead-acid batteries.

### BRIEF DESCRIPTION OF THE DRAWINGS:

FIG. 1 is a SEM image of a cross-section of a lead-graphene composite metal material obtained by reacting a lead melt with tungsten carbide at a temperature of 700° C. containing 5 wt. % of carbon, including in the form of graphene inclusions;

FIG. 2 shows the EDS spectrum of the composite shown in FIG. 1;

FIG. 3 is a X-Ray diffraction digram of the composite shown in FIG. 1;

FIG. 4 shows the Raman spectrum of carbon inclusion as graphene in the composite shown in FIG. 1;

FIG. 5 is a SEM image of a cross-section of a lead-graphite composite obtained by reacting a lead melt with a silicon carbide powder at 750° C. containing 2.55 wt. % of carbon;

FIG. 6 shows the EDS spectrum of the composite shown in FIG. 5;

FIG. 7 shows the Raman spectrum of the carbon inclusion as graphite in the composite shown in FIG. 5;

FIG. 8 is a SEM image of the cross-section of a lead-graphene composite obtained by reacting a lead melt with a tartaric acid powder at 800° C. containing 1.28 wt. % of carbon;

FIG. 9 shows the EDS spectrum of the composite shown in FIG. 8;

FIG. 10 shows the Raman spectrum of carbon inclusion-graphene in the composite shown in FIG. 8;

FIG. 11 is a photograph of a lead-graphene composite;

FIG. 12 is a photograph of a lead-graphite composite;

FIG. 13—DSC melting curves of lead and lead-graphene composite;

FIG. 14 shows the general view of the lead electrode after 3 months under free corrosion;

FIG. 15 shows a general view of the lead-graphene electrode after 3 months under free corrosion;

FIG. 16 shows a general view of the lead-graphite electrode after 3 months under free corrosion;

FIG. 17 shows a general view of the lead sulfate crystals on a lead electrode after 3 months of current-free corrosion;

FIG. 18 shows a general view of lead sulphate crystals on a lead-graphene electrode after 3 months of current-free corrosion;

FIG. 19 is a general view of lead sulphate crystals on lead-graphite electrode after 3 months of current—free corrosion;

FIG. 20 shows typical curves of 50th cycle for lead, lead-graphite (LC1) and lead-graphene (LC2) positive electrodes in a solution of sulfuric acid;

FIG. 21 shows the curves of 50th cycle for lead, lead-graphite (LC1) and lead-graphene (LC2) positive electrodes after 14 weeks of current-free corrosion in a solution of sulfuric acid;

FIG. 22 shows the cycle curves 50 for lead, lead-graphite (LC1) and lead-graphene (LC2) negative electrodes;

FIG. 23 shows the cycle curves 50 for lead, lead-graphite (LC1) and lead-graphene (LC2) negative electrodes after 14 weeks of current-free exposure in a solution of sulfuric acid.

### EMBODIMENTS OF THE INVENTION

Example 1-3 show a method for synthesizing lead-carbon metal composite materials for lead-acid battery electrodes.

### EXAMPLE 1

An alumina crucible was placed in a vertical heating furnace, 40 g of a dry mixture of lithium and potassium chlorides with potassium fluoride containing 15 g of tungsten carbide powder with a particle size of up to 50 μm were placed on its bottom. Over the carbide-containing salt mixture, lead pellets with a diameter of up to 5 mm with a purity of 99.9% by weight were placed onto which 10 g of a finely divided mixture of chlorides and fluorides of lithium and potassium were poured. After that, the furnace was heated to a temperature of 700° C. and held in an air atmosphere for 5 hours. At the same time, the carbide ion passed into the lead melt to form a lead-carbon composite. After high-temperature interaction, the lead-graphene composite was cooled at a rate of less than 0.1 deg/min.

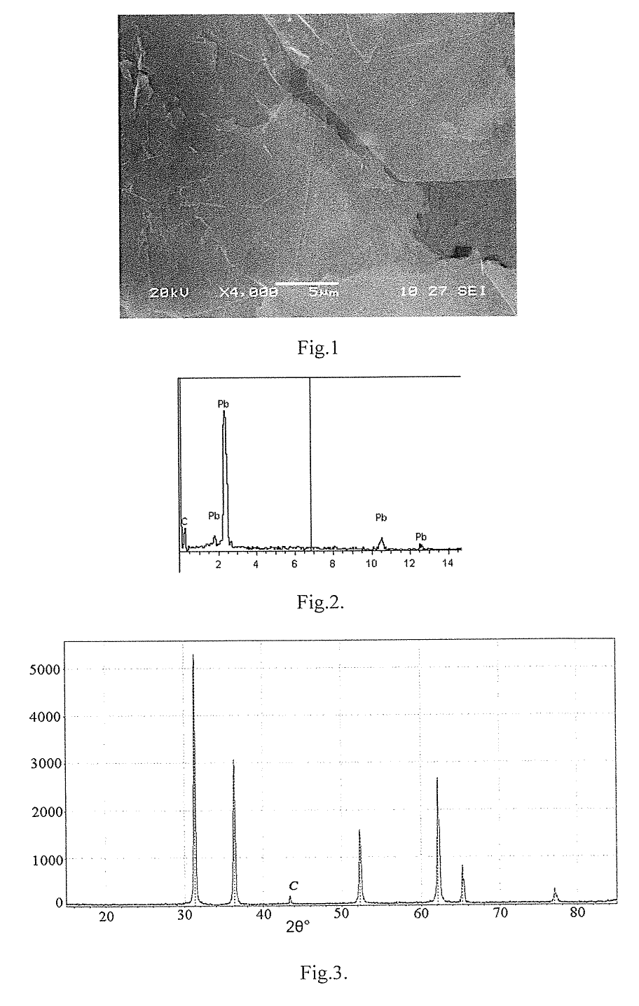

In the cross-sectional image of the lead-carbon composite material shown in FIG. 1, it can be seen that the carbon formed inside the lead melt forms graphene layers 1 to 3 that are evenly distributed throughout the entire thickness of the lead-graphene composite. The EDS spectroscopy data presented in FIG. 2 indicate the production of a lead-carbon composite with 5% by weight carbon. The X-ray diffraction diagram shown in FIG. 3 contains lead and carbon peaks, indicating the release of carbon in lead without the formation of lead carbide, which would be an undesirable component. FIG. 4 shows the Raman spectrum of the carbon inclusion, graphene.

### EXAMPLE 2

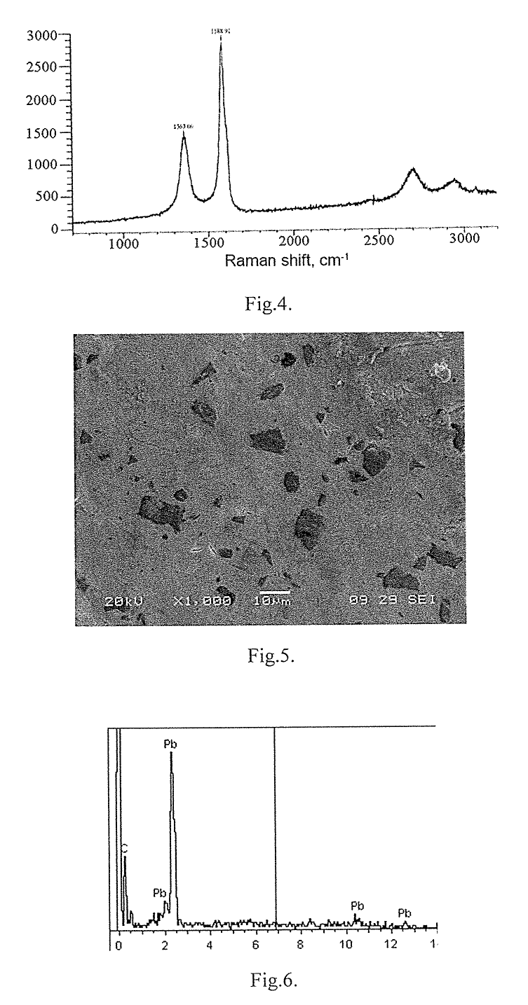

An alumina crucible was placed in the vertical heating furnace, 40 g of a dry mixture of chlorides, lithium, sodium, potassium, cesium containing 0.5 g of silicon carbide powder with a particle size of up to 100 μm were placed on its bottom. A disk of high purity lead was placed on top of the carbide-containing salt mixture, to which 10 g of the same finely divided salt mixture was poured, after which the furnace was heated to a temperature of 750° C. and held in an air atmosphere for 2 hours. In this case, the carbide ion passed into an aluminum melt with the formation of a lead-carbon composite. After high-temperature interaction, the lead-graphene composite was rapidly cooled in a water-cooled crucible. The cross-sectional image of the lead-carbon composite is shown in FIG. 5. The EDS spectroscopy data presented in FIG. 6 indicate the production of a lead-carbon composite with a content of 2.55 wt. % of carbon. In FIG. 7 shows the Raman spectrum of the carbon inclusion-graphite.

### EXAMPLE 3

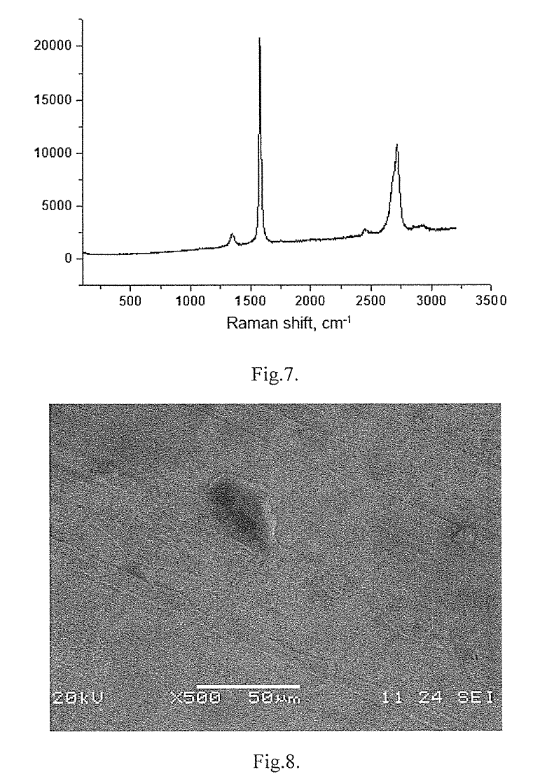

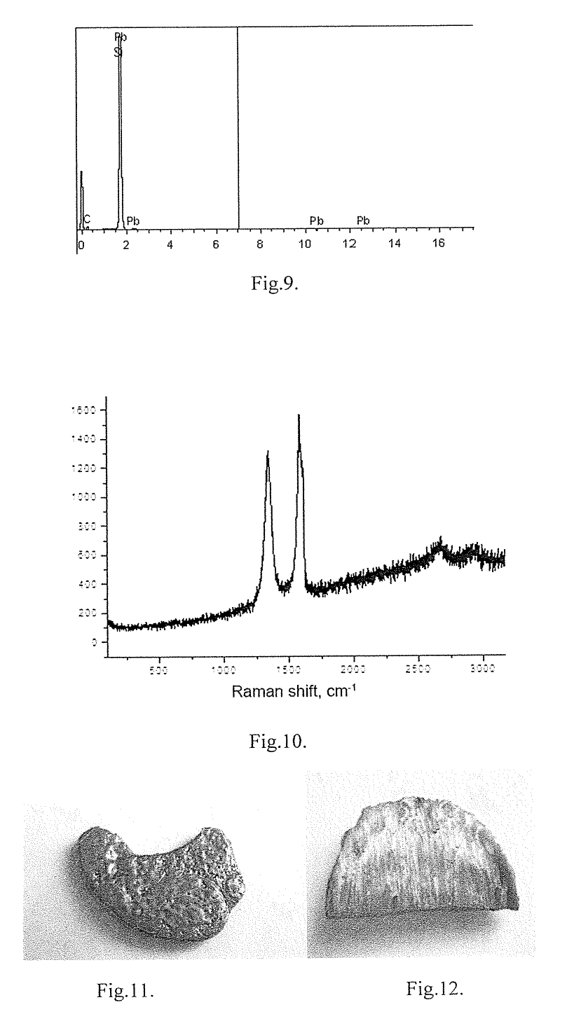

An alumina crucible was placed in a vertical heating furnace, 40 g of a dry mixture of sodium, potassium, cesium chloride and ammonium fluoride containing 3.5 g of a tartaric acid powder were placed on its bottom. Over the carbon-containing salt mixture, granules of lead alloy Cl were placed on which 10 g of the same finely divided salt mixture were poured. After that, the furnace was heated to a temperature of 800° C. and held in an air atmosphere for 1 hour. In this case, the carbide ion passed into the lead melt to form a lead-carbon composite. After high-temperature interaction, the lead-graphene composite was cooled together with the furnace. The cross-sectional image of the lead-carbon composite material is shown in FIG. 8. The EDS spectroscopy data presented in FIG. 9 indicate the production of a lead-carbon composite with a content of 1.28 wt. % of carbon. In FIG. 10 shows the Raman spectrum of carbon inclusion—graphene.

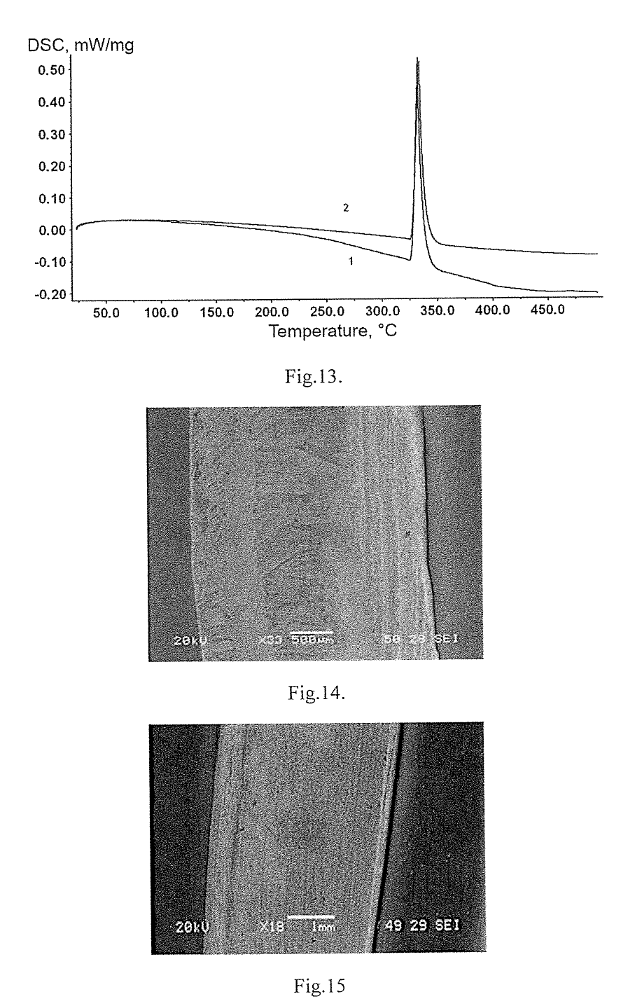

The resulting composites are a typical metal with a characteristic metallic sheen (FIG. 11,12). Studies using the DSC method have shown that the melting point of lead-graphene composites is exactly equal to the melting point of pure lead (FIG. 13). The density of lead-carbon composites, depending on the carbon content, is from 7.34 to 9.1 g cm⁻³. The hardness of lead-graphene and lead-graphite composites is 20-25% higher than that of pure lead and is equal to the hardness of modern industrially used alloys. The electrical and thermal conductivity of lead-graphene and lead-graphite composites is 25-28% higher than that of pure lead. This means that the use of lead-graphene and lead-graphite composites instead of lead in any technological processes does not mean a change in the existing technologies for the production of a lead-acid battery with a significant improvement in service characteristics.

At chemical interaction of salt melt containing metal or nonmetal carbides with molten lead, dispersion-hardened composites with a volumetric content of 0.1 to 10 wt. % of carbon in the form of graphene layers or graphite crystals, depending on the process temperature, concentration and type of carbon-containing additive.

Thus, the claimed method makes it possible to obtain lead-carbon composites with a high carbon content uniformly distributed throughout the lead metal composite in the form of graphene and graphite inclusions with an average particle size of 10 nm to 100 μm, without the formation of an undesirable lead carbide product, but with improved structure and physical properties.

### INDUSTRIAL APPLICABILITY

Examples 4-8 show the results of long-term corrosion and electrochemical tests of lead-graphene and lead-graphite metallic composite materials under the conditions of the positive and negative electrodes of lead-acid batteries before and after long corrosion tests. These tests were carried out to show the possibility of using the synthesized composite material as a positive and negative lead of a lead-acid battery, samples of this material were tested under the conditions of a lead-acid battery in a 32% solution of sulfuric acid at room temperature.

### EXAMPLE 4

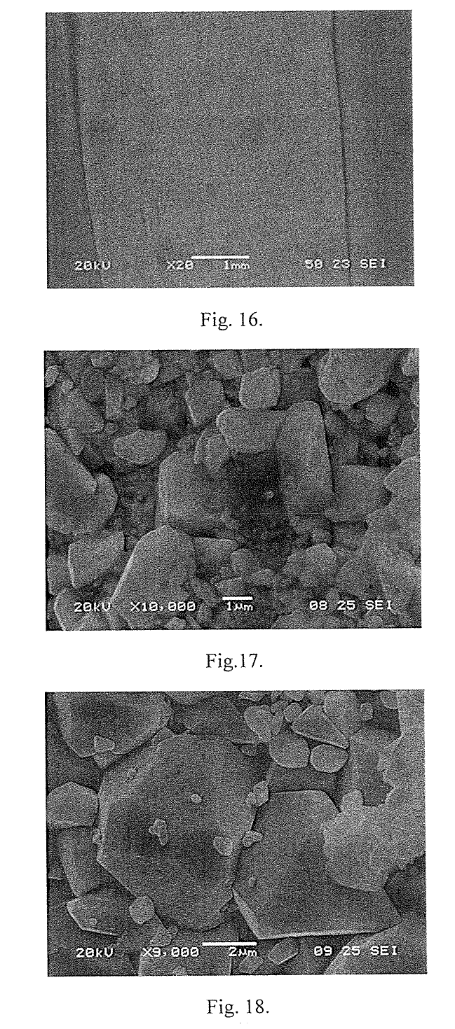

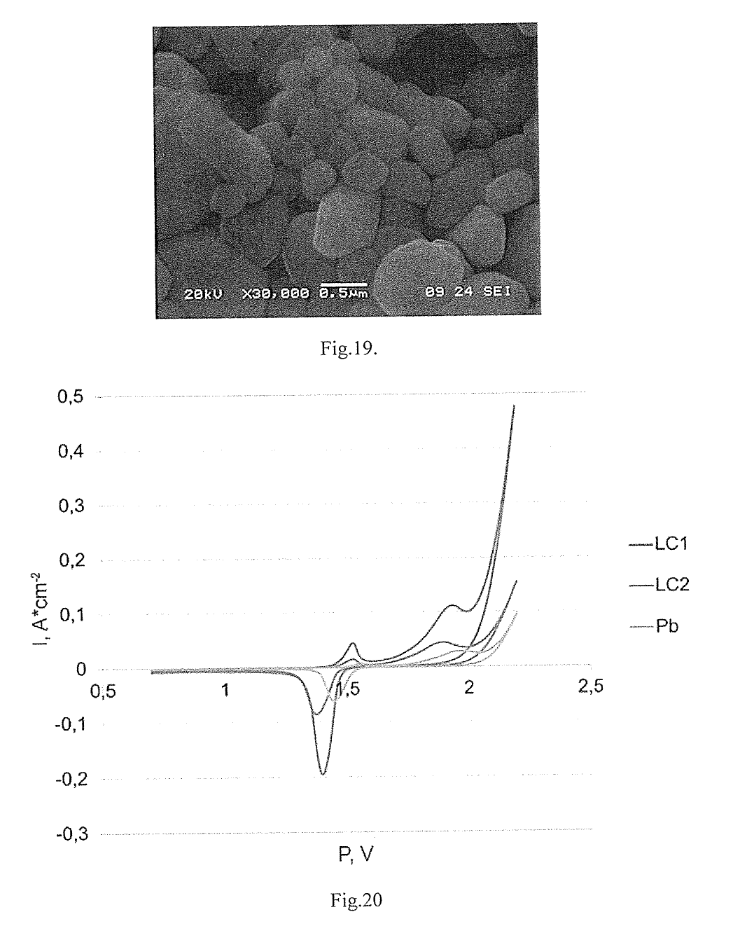

In nine glass beakers, we place three lead samples, three samples of lead-graphite composite with 1% graphite and three samples of lead-graphene composite with 1% by weight of graphene. Pour in each glass of 200 ml of sulfuric acid concentration of 32% by weight. We hold the samples, taking out 1 time a week, washing off the acid and drying, after which we carry out weighing. The total duration of the corrosion test was 3 months. General view of the electrodes after 3 months. the lead electrode is shown in FIG. 14, the lead-graphite is shown in FIG. 16, and the lead-graphene is shown in FIG. 15. The photos of the lead sulfate crystals of the lead electrode obtained by means of a scanning electron microscope are shown in FIG. 17, the lead- in FIG. 19, the lead-graphene one in FIG. 18.

### EXAMPLE 5

The cyclic voltammetry of lead, lead-graphite and lead-graphene electrodes was carried out with the AUTOLAB 302N potentiostat at a sweep speed of 10 mV s⁻¹ relative to the silver chloride reference electrode in the interval of the positive electrode operation from −0.70 to +2.5 V.

Typical curves 50th cycle for lead, lead-graphite (LC1) and lead-graphene (LC2) positive electrodes are shown in FIG. 20. They have only one discharge peak and it is associated only with a direct discharge of lead dioxide without any carbon contribution. The current density of the discharge peak of the lead-graphite positive electrode is 5 times higher than that of the lead electrode, and the current density of the discharge peak of the lead-graphene electrode is 8 times higher than that of the lead electrode. Cycling of lead-graphene and lead-graphite electrodes passes without deterioration of electrochemical characteristics, breakdown and destruction of the electrode.

### EXAMPLE 6

Cyclic voltammetry of lead, lead-graphite and lead-graphene electrodes after corrosion tests for 3.5 months was carried out with the AUTOLAB 302N potentiostat at a sweep speed of 10 mV s⁻¹ relative to the silver chloride reference electrode in the interval of operation of the positive electrode of the SCA from +0.7 B to +2.5 V.

Electrochemical cycling of pure lead after 14 weeks in a solution of sulfuric acid led to unsatisfactory results. The absence of an oxidation peak on the current-voltage curves is the reason for the interruption of the ability to cycle lead electrode after the 50th cycle due to the formation of a large amount of dense non-conducting nanocrystalline lead oxide with an average crystal size of about 100 nm.

Cyclic voltammograms of lead-graphene and lead-graphite metal composites after a 14-week exposure to sulfuric acid are completely analogous to the curves of the same composites prior to corrosion tests and show the full spectrum of possible anode reactions. They also have only one discharge peak and discharge current values are also close to the original.

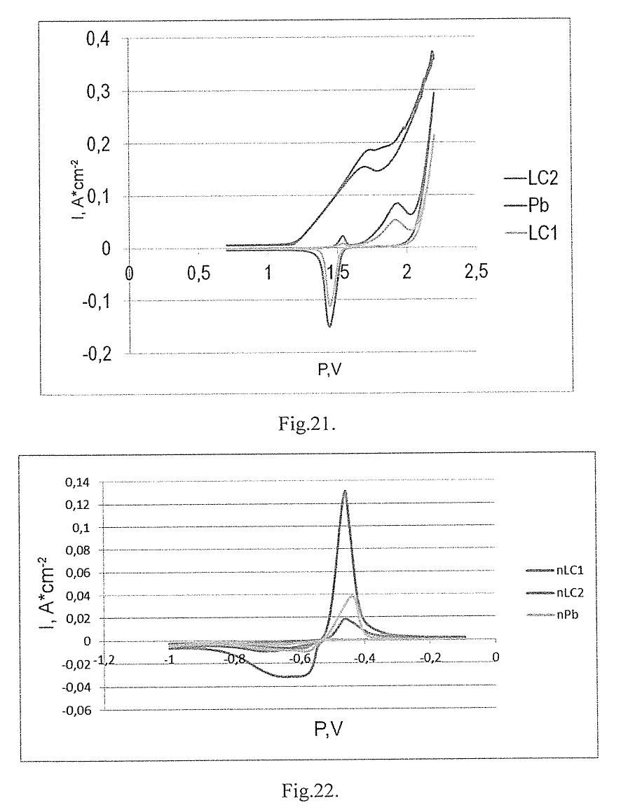

Typical curves 50th cycle for lead, lead-graphite (LC1) and lead-graphene (LC2) positive electrodes after 14 weeks of non-aging in sulfuric acid are shown in FIG. 21. It is shown that the current density of the discharge peak of the lead-graphite positive electrode is 5 times higher than that of the lead lead electrode, and the peak current density of the lead-graphene electrode is 8 times higher than that of the lead lead electrode. Cycling of lead-graphene and lead-graphite electrodes passes without deterioration of electrochemical characteristics, breakdown and destruction of the electrode.

### EXAMPLE 7

Cyclic voltammetry of lead, lead-graphite and lead-graphene electrodes was carried out with the AUTOLAB 302N potentiostat at a sweep speed of 10 mV s⁻¹ relative to the silver chloride reference electrode in the interval of operation of the negative SCA electrode from −0.1V to −1.0 V.

Typical curves 50^{th} cycle for lead, lead-graphite (LC1) and lead-graphene (LC2) negative electrodes are shown in FIG. 22. They have only one discharge peak, and it is associated only with a direct discharge of lead sulfate without any carbon contribution. The current density of the discharge peak of the lead-graphite negative electrode is 2 times higher than that of the lead electrode, and the peak current density of the lead-graphene electrode is 8 times higher than that of the lead electrode. Cycling of lead-graphene and lead-graphite electrodes passes without deterioration of electrochemical characteristics, breakdown and destruction of the electrode.

### EXAMPLE 8

Cyclic voltammetry of lead, lead-graphite and lead-graphene electrodes after corrosion tests for 3.5 months was carried out with the AUTOLAB 302N potentiostat at a sweep speed of 10 mV s relative to the silver chloride reference electrode in the interval of operation of the negative electrode of the CKA—from −0.1B to -1.0 V.

Cyclic voltammograms of lead, lead-graphene and lead-graphite metal composites after a 14-week exposure to sulfuric acid are completely analogous to the curves of the same composites prior to corrosion tests and show the full range of possible cathodic reactions. They also have only one peak discharge and the discharge current values of lead and lead graphite are also close to the original, while the peak current density of the discharge of the lead-graphene electrode is slightly lower than that of the initial to corrosion tests.

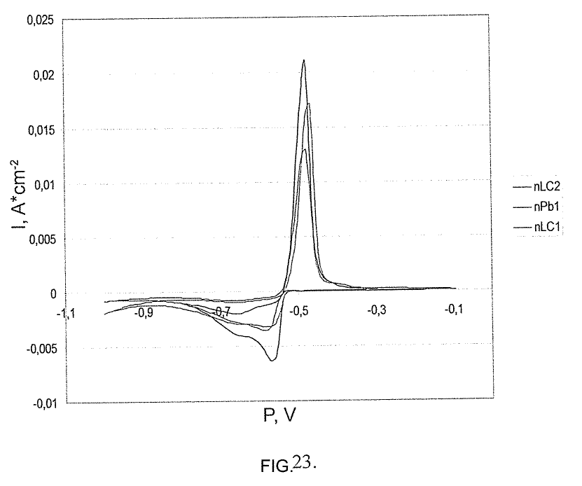

Typical cycle curves 50 for lead, lead-graphite (LC1) and lead-graphene (LC2) negative electrodes after corrosion testing are shown in FIG. 23. It is shown that the current density of the discharge peak of the lead-graphite positive electrode is 5 times higher than that of the lead lead electrode, and the peak current density of the lead-graphene electrode is 8 times higher than that of the lead lead electrode. Cycling of lead-graphene and lead-graphite electrodes passes without deterioration of electrochemical characteristics, breakdown and destruction of the electrode.

Examples 4-8 show that the corrosion rate of lead-graphite and lead-graphene electrodes is higher than the corrosion rate of pure lead, but much lower than the corrosion rate of currently used lead-bismuth, lead-antimony and lead-calcium alloys. In addition, unlike the above-mentioned alloys, lead-carbon metal composite materials exhibit no tendency to pitting and intergranular corrosion during long corrosion tests, which is the reason for the destruction of the current lead of the positive electrode, which in turn significantly reduces the life of lead acid batteries (FIG. 14-16). The only corrosion product of lead-carbon composites, as well as of pure lead, is the lead sulfate according to X-ray diffraction analysis, which avoids contamination of the sulfuric acid electrolyte by undesirable impurities. The increase in the corrosion rate of lead-graphene and lead-graphite metallic composite materials in comparison with lead is caused by the formation of larger, well-cut lead sulfate crystals (FIGS. 17-19), which are more electrochemically active than non-shaped, fine crystals, formed on lead. The yield of lead ions in the sulfuric acid electrolyte during corrosion of the lead-graphene composite is even slightly less than for pure lead, and the lead-graphite composite is larger within the measurement error, namely 0.038 mg cm⁻² for pure lead, 0.018 mg cm⁻² for a lead-graphene metal composite material and 0.054 mg·cm⁻² for a lead-graphite metallic composite material.

An increase in the corrosion rate of lead-carbon composite materials with respect to pure lead indicates an increased electrochemical activity of these metallic materials. This was recorded during the long cyclic tests of lead-graphene and lead-graphite electrodes under the conditions of the positive and negative electrodes of lead acid batteries. It is shown that the discharge characteristics of lead-graphite and especially lead-graphene electrodes tested both under positive conditions (FIG. 20, 21) and negative electrodes (FIG. 22, 23) are much higher than for lead lead. The most important distinctive feature of the use of lead-graphite and lead-graphene electrodes is the fact that even after long tests on the surface of metal electrodes, there is no formation of lead oxide—a substance possessing dielectric properties and impairing the electrochemical process at the electrodes.

Investigation of the electrochemical discharge process of lead-graphite and lead-graphene electrodes after a 3-month non-continuous aging in a solution of sulfuric acid showed an absolute advantage in the use of lead-graphite and lead-graphene metal composites as a positive and negative electrode (FIG. 20-23). The lead electrode is completely covered by a layer of lead oxide and is incapable of further functioning as a current lead. While the lead-graphite electrode has a discharge characteristic of 10% worse than without non-holding, and the characteristics of the lead-graphene electrode remain the same without signs of deterioration. Consequently, lead acid batteries with lead-graphite and lead-graphene electrodes can be for a long time in a half-charged and even completely discharged state, which is completely unacceptable for conventional acid batteries and makes them competitive with alkaline batteries.

The introduction of carbon in the form of graphene and graphite with good wettability in the lead metal matrix allows solving a number of important technical problems. Thus, the proposed lead-graphite and lead-graphene metal composite materials have a density of 7.8 to 9 g cm⁻³ at an initial lead density of 11.34 g cm⁻³. They have an electrical conductivity of 15-20% higher and a hardness of 20-25% higher than that of the lead.

The melting point of lead-graphite and lead-graphene metal composite materials exactly corresponds to the melting point of pure lead.

Thus, the use of lead-graphite and lead-graphene composites allows to solve the problem of radical improvement of specific electrochemical and corrosive characteristics of a lead-acid battery without a drastic change in the process of battery production.

1. Lead-carbon metal composite material for lead-acid battery electrodes, including lead and carbon, characterized in that the material contains from 0.1 to 10% by weight of carbon, lead is the remainder, the structure of the material comprising carbon allotropic modifications from graphene to graphite.

2. A method for synthesizing lead-carbon metal composition materials for lead-acid battery electrodes, characterized in that lead or its alloys are melted in a melt of alkaline and/or alkaline earth metal halides containing from 1 to 20 wt. % of metal carbides or non-metals with a particle size of 100 nm to 200 μm, or solid organic substances, for 1-5 hours at a temperature of 700-900° C.
